(19) United States
(12) Patent Application Publication
(10) Pub. No.: US 2013/0058734 A1
(43) Pub. Date: Mar. 7, 2013

(54) COMBINED DRILL AND REAMER TOOL

(71) Applicant: Vladimir D. Volokh, Maa'lot-Tarshiha (IL)

(72) Inventor: VLADIMIR D. VOLOKH, Maa'lot-Tarshiha (IL)

(21) Appl. No.: 13/404,726

(22) Filed: Feb. 24, 2012

(30) Foreign Application Priority Data
Feb. 27, 2011 (IL) 211443

(51) Int. Cl. B23B 51/08

(52) U.S. Cl. 408/223

(57) ABSTRACT

A drill-reamer tool comprises a shank portion and a cutting portion coaxial with the shank portion, the cutting portion having an operational portion comprising at least one twist drill spiral roughing cutting edge associated with a land margin, a land clearance and a flute. The cutting portion further comprises at least one spiral finishing edge interlaced with the spiral roughing cutting edge and having associated therewith only a land margin and a flute. The land margin of said finishing edge being provided with a plurality of reamer cutting edges spiraling in an opposite direction to that of the roughing cutting edge. The reamer cutting edges being configured to cut a larger hole than said roughing edge. The operational portion being dimensioned such that during operation, both the roughing cutting edge and the reamer cutting edge are simultaneously operative.

### BACKGROUND

1. Field of the Invention

The present invention relates to a combination drill-reamer tool, more particularly, to a combined drill and reamer that performs both drilling and reaming simultaneously in a short axial feeding stroke.

2. Background Information

Combination drill-reamer tools, also known as “D-Reamers”, that drill and ream in one operation, have long been in industrial use. By combining both operations into one, a through hole can be drilled and reamed from solid material to finished hole size in one production pass, reducing setup time and cost per operation.

A simple drill-reamer tool consists of a two flute front twist drill portion and a multi-flute rear reamer portion combined along a shared axis into one tool. The reamer portion, having the same spiral flutes as the twist drill portion, is provided with two or more reamer cutting edges associated with each flute. Due to the twist drill clockwise spiral flutes extending to the rear reamer portion, this drill-reamer tool tends to self feed during the reaming phase, possibly leading to a wedging action and consequent breakage.

An alternative drill-reamer tool that is more complex to manufacture, provides a typical counter clockwise spiral to the multi-flute rear reamer portion which looks like an ordinary reamer. However the absence of the deep drill flutes along the reamer portion deteriorate chip disposal rate and requires pecking motion during usage to allow removal of chips.

In order to benefit from the advantages of both types of drill-reamer tools mentioned above, U.S. Pat. No. 4,507,028 to Masahiro, describes a cutting tool combining a front drill portion and a rear reamer portion along one axial line, having twist drill flutes through both portions and reamer cutting edges spiraling in the opposite direction to that of the drill cutting edges, whereby the tool can provide a through hole in a workpiece having a smooth surface with one forward rotating operation.

However, as noted by Masahiro, such drill-reamer tool must be used in through hole applications to work correctly and hold size. The drill portion of the drill-reamer must be longer than the thickness of the portion to be drill-reamed, such that the drill tip should drill through and be finished cutting before the reamer portion starts to cut. For this reason, the entire tool length and hence the required axial feeding stroke is considerably larger and takes a longer time than required for only drilling the hole.

Modern printed circuit boards (PCBs) or avionic structural elements, made of fiber reinforced plastics require accurate position and tight tolerances of drilled holes. Especially given the many hundreds or thousands of holes on most circuit boards, it is obvious that time saving of each single operation is multiplied by the large number of holes and becomes a significant component of the total cost.

Consequently, in order to decrease the required axial feeding stroke and drill-ream cycle time, in particular but not limited to operations on fiber reinforced plastics, a new approach is desired which can eliminate the above disadvantages inherent in the conventional drill-reamer construction.

### SUMMARY OF THE INVENTION

Accordingly, present invention provides an improved combination drill-reamer of the type referred to above which enables simultaneous drilling and reaming along a short axial feeding stroke.

The drill-reamer tool comprises a shank portion and a cutting portion coaxial with the shank portion, the cutting portion having an operational portion comprising at least one twist drill spiral roughing cutting edge associated with a land margin, a land clearance and a flute. The cutting portion further comprising at least one spiral finishing edge interlaced with the spiral roughing cutting edge and having associated therewith only a land margin and a flute. The land margin of the finishing edge being provided with a plurality of reamer cutting edges spiraling in an opposite direction to that of the roughing cutting edge. The reamer cutting edges being configured to cut a larger hole than the roughing edge. The operational portion being dimensioned such that during operation both the roughing cutting edge and the reamer cutting edge are simultaneously operative.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a perspective view of a drill-reamer made in accordance with an embodiment of the present invention;

FIG. 2 is a perspective view of a partially processed drill-reamer, such as shown in FIG. 1, shown unfinished for clarity;

FIG. 3 is an enlarged front view of the drill-reamer tip of FIG. 1;

FIG. 4 is an enlarged side view of the drill-reamer tip of FIG. 1;

FIG. 5 is a schematic sectional view of the drill-reamer of FIG. 1;

FIG. 6 is a schematic sectional view of a drill-reamer made in accordance with another embodiment of the present invention; and

FIG. 7 is a schematic sectional view of a drill-reamer made in accordance with yet another embodiment of the present invention.

### DESCRIPTION OF THE PREFERRED EMBODIMENTS

In the following description, identical elements that appear in more than one figure or that share similar functionality will be indicated by identical reference numerals.

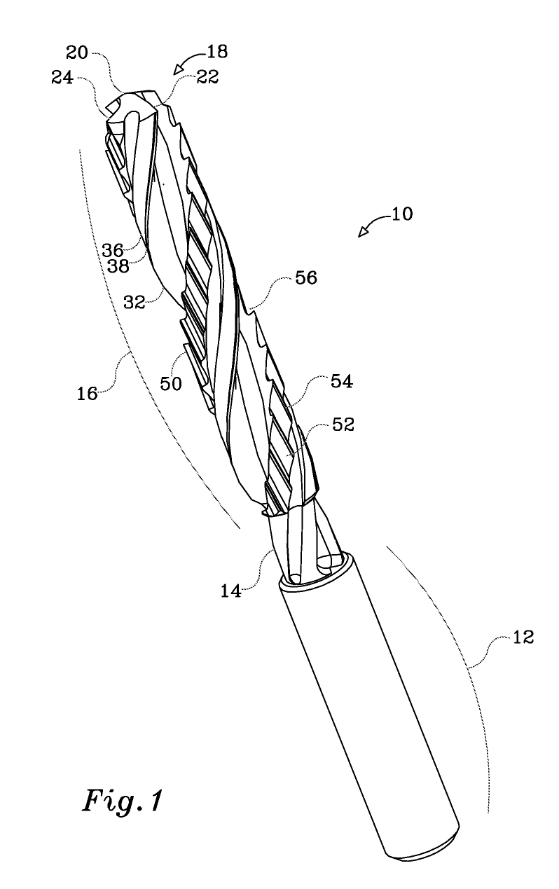

With reference to FIG. 1, there is shown a drill-reamer tool generally referenced 10, made in accordance with an embodiment of the present invention. The drill-reamer 10 comprises a shank portion 12 for clamping in a chuck or a collet of a drill-press or any other drilling equipment, a short neck 14 and a cutting portion 16 which serves both the drilling and the reaming functionality, all of which share the same longitudinal axis.

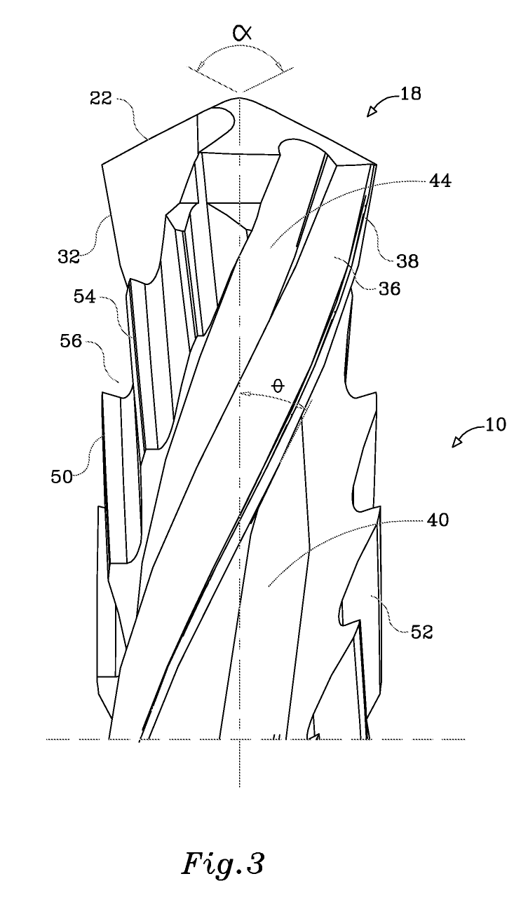

A twist drill tip, generally referenced 18, located in front of the cutting portion 16, includes a chisel edge 20, cutting lips 22 and heels 24, as typically found in ordinary twist drills. The point angle α (FIG. 3) is determined according to the workpiece material and is usually set to 118° for general purpose applications.

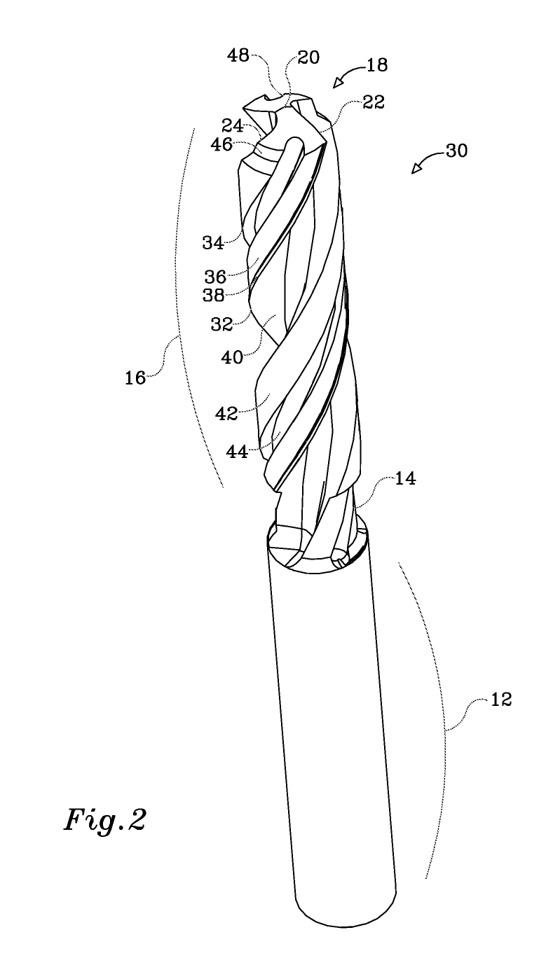

Due to the complex geometry of the cutting portion 16, it will be easier to explain the nature of the invention by referring to FIG. 2, which is a perspective view of a partially processed drill-reamer 30 taken out of the production line before processing a step of grinding the reamer cutting edges 50. The cutting portion 16 of the partially processed drill-reamer 30 comprises at least one spiral roughing cutting edge 32, or for simplicity: roughing edge 32 and at least one spiral finishing cutting edge 34, or for simplicity: finishing edge 34. Typically the drill-reamer tool 30, as specifically shown in FIG. 2, is provided with a pair of right hand spiral roughing edges 32 and two or more spiral finishing edges 34. The roughing edges 32 are associated with land margins 36, land clearance 38, and flutes 40 like those found in an ordinary twist drill. The two or more spiral finishing edges 34 are associated with only wide land margins 42 and flutes 44, which may be shallower than the roughing edge flutes 40. It will be understood that the finishing edges 34 are not true cutting edges due to the lack of land clearance which is necessary for reaming a hole with fine, accurate wall surface on the workpiece material.

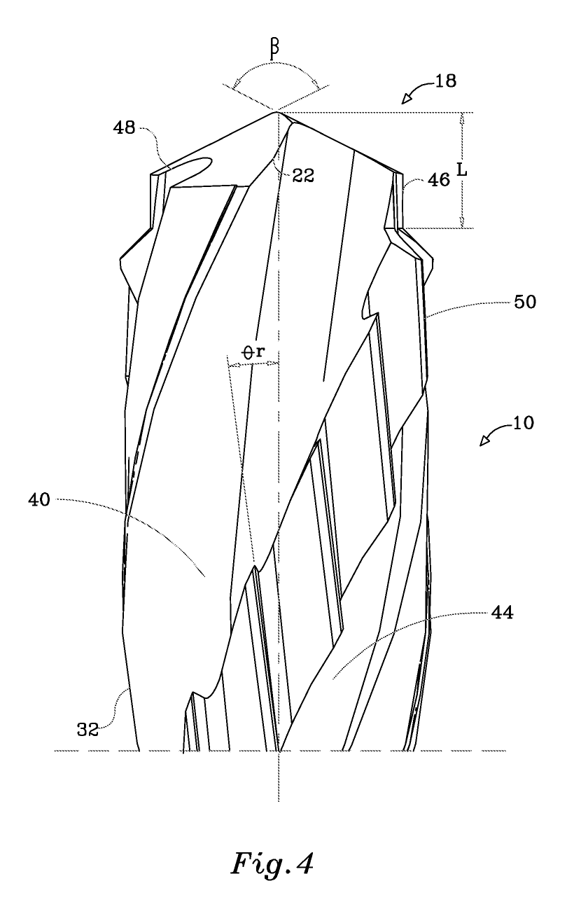

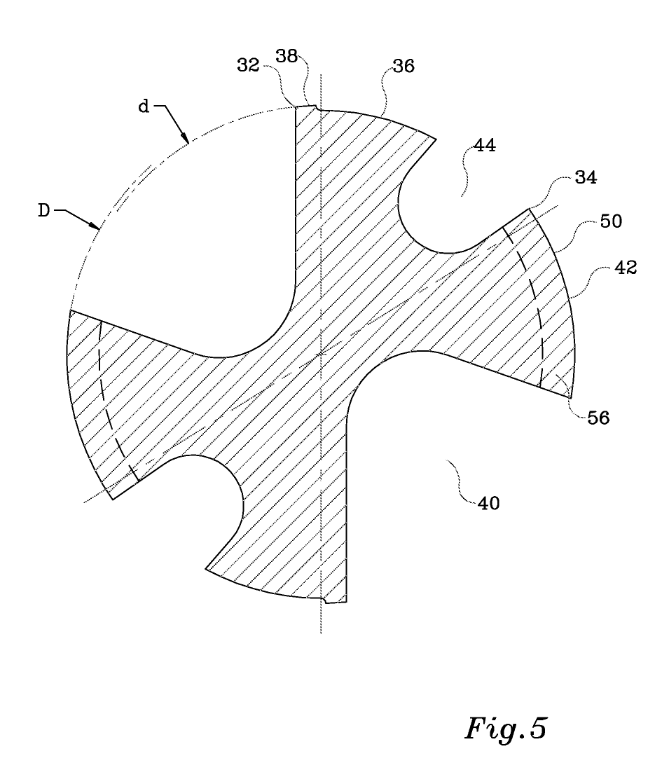

With further reference to FIG. 2, it is seen that the finishing cutting edges 34 are stepped down in diameter towards the tip 18, forming a short leading portion 46 of length L (FIG. 4). Along length L, only the lips 22 and the roughing edges 32 are operative, consequently, the finishing edges 34 start cutting only after the drill-reamer tool has made a leading hole of the smaller diameter d (FIG. 5) and depth L in the workpiece material. Optionally, the point angle β (FIG. 4) of the lips 48 of the finishing edges 34, is made acuter than the point angle α (FIG. 3) of the lips 22 of the roughing edges 32, leading to the same effect of subsequent operation of the finishing edges 34 as described above.

With reference to FIGS. 1, 3, and 4, the final drill-reamer 10, is processed with a step of grinding or otherwise performing plurality of straight or left handed spiral reamer cutting edges 50. The reamer cutting edges 50 are associated with reamer land clearance 52, reamer land margins 54, sometimes defined “primary clearance”, and shallow reamer flutes 56. The reamer cutting edges 50 are provided only to the wide land margins 42 associated with the finishing edges 34 (FIG. 2), which as described above, are not true cutting edges until provided with the reamer cutting edges 50, land clearance 52, land margin 54 and flutes 56. The reamer cutting edges 50 are spiraling in the opposite direction to that of the roughing edges 32 in order to prevent self feed as mentioned above. The number of reamer cutting edges 50 which are typically arranged in a circular array is determined according to the diameter of the tool and range between 6 to 24 for diameters of up to 50 mm.

With reference to FIG. 5, there is shown a schematic sectional view of the drill-reamer of FIG. 1, the smaller circle marked d represents the size of the hole cut by the roughing edges 32 and the larger circle marked D represents the size of the hole cut by the reamer cutting edges 50. As shown, the reamer cutting edges 50 cut a larger hole than the roughing edges 32.

However, in contrast to hitherto-proposed drill-reamers, the depth L of the leading hole can be significantly smaller than the thickens of the workpiece material, such that following drilling of the leading hole, both the roughing edges 32 and the reamer cutting edges 50 are simultaneously operative.

The helix angle θ (FIG. 3) of the spiral roughing edges 32 is typically a right hand helix ranging between 13° and 40°, and the helix angle θr (FIG. 4) of the spiral reamer cutting edges 50 is typically a left hand helix ranging between 0° (straight) to 45°, both depending on the workpiece material.

In operation, the leading portion 46 first creates a leading hole of the smaller diameter d and depth L in the workpiece material which acts like a centering drill and keeps the true position of the drill-reamer tool. During progress of the drill process, the reamer cutting edges 50 enlarge and ream the hole precisely to the final diameter D. The deep roughing edge flutes 40 provide fast disposal of drill chips, including portions of the chips produced by the reamer cutting edges 50. The shallower finishing edge flutes 44 provide disposal of the lesser volume reamer chips, thus eliminating the pecking motion as described above with reference to the prior art.

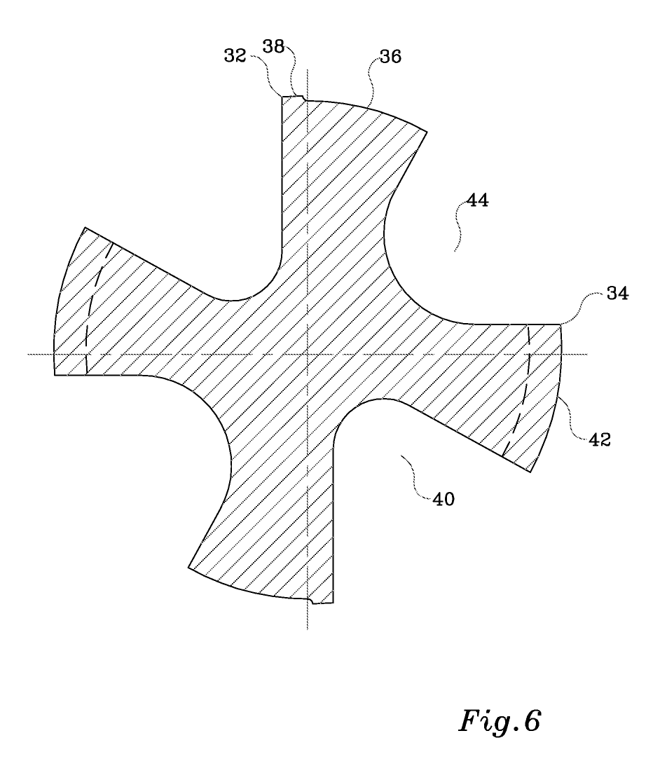

With reference to FIG. 6, there is shown a schematic sectional view of a drill-reamer made in accordance with another embodiment of the present invention, wherein the roughing edges 32 and the finishing edges 34 are associated with teeth of equal cross section, equally spaced apart in a circular array such as found for instance in four flute end mills, accordingly, the spacing flutes 40, 44 are also of equal depth and size.

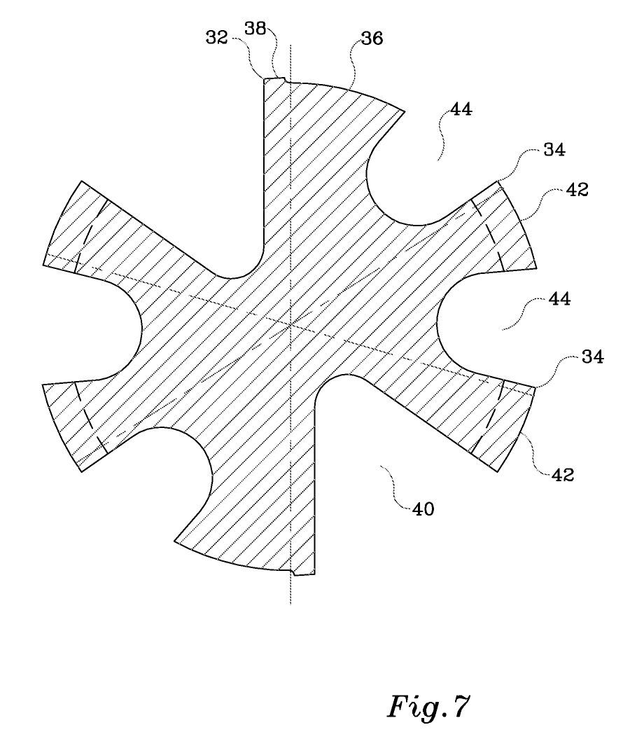

With reference to FIG. 7, there is shown a schematic sectional view of a drill-reamer made in accordance with yet another embodiment of the invention, wherein two roughing edges 32 and four finishing edges 34 are provided. The four finishing edges are provided with straight or left handed spiral reamer cutting edges 50 as described above. It will be understood that any number of alternating or following roughing and finishing edges may be provided and fall within the scope of the present invention.

It will be evident to those skilled in the art that the invention is not limited to the details of the foregoing illustrated embodiments and that the present invention may be embodied in other specific forms without departing from the scope of the claims.

What is claimed is:

1. A drill-reamer tool comprising:
a shank portion and a cutting portion coaxial with the shank portion, said cutting portion having an operational portion comprising at least one twist drill spiral roughing cutting edge associated with a land margin, a land clearance and a flute, said cutting portion further comprising at least one spiral finishing edge interlaced with the spiral roughing cutting edge and having associated therewith only a land margin and a flute, the land margin of said finishing edge being provided with a plurality of reamer cutting edges spiraling in an opposite direction to that of the roughing cutting edge, said reamer cutting edges being configured to cut a larger hole than said roughing edge, said operational portion being dimensioned such that during operation both the roughing cutting edge and the reamer cutting edge are simultaneously operative.

2. The drill-reamer tool of claim 1, wherein said cutting portion comprises a pair of spiral roughing edges and at least two spiral finishing edges.

3. The drill-reamer tool of claim 1, comprising in front of said cutting portion a drill tip including a chisel edge, cutting lips and heels.

4. The drill-reamer tool of claim 3 for use with a workpiece of depth no less than a length of the operational portion, wherein the finishing edges are stepped down in diameter towards the drill tip forming a short leading portion wherein only the lips and the roughing edges are operative.

5. The drill-reamer tool of claim 3, wherein the point angle of the lips of the finishing edges is more acute than the point angle of the lips of the roughing edges.

6. The drill-reamer tool of claim 1, wherein the reamer cutting edges are associated with a reamer land clearance, a reamer land margin and a shallow reamer flute.

7. The drill-reamer tool of claim 1, wherein the flutes associated with the finishing edge are shallower than the flutes associated with the roughing edge.

8. The drill-reamer tool of claim 1, wherein the helix angle of the spiral roughing edges is a right hand helix angle ranging between 13° and 40°, and the helix angle of the spiral reamer cutting edges is a left hand helix angle ranging between 0° to 45°.

9. The drill-reamer tool of claim 1, wherein the reamer cutting edges are arranged in a circular array of between 6 to 24 cutting edges.

10. The drill-reamer tool of claim 1, wherein the roughing edges and the finishing edges are associated with teeth of equal cross section, equally spaced in a circular array by flutes which are also of equal depth and size.

11. The drill-reamer tool of claim 1, wherein two roughing edges and four finishing edges are provided.
